(19) United States
(12) Patent Application Publication
(10) Pub. No.: US 2025/0265913 A1
(43) Pub. Date: Aug. 21, 2025

(54) CRIME EMERGENCY SITUATION MANAGEMENT SYSTEM WITH CRIME PREVENTION AND EVACUATION FUNCTIONS

(71) Applicant: Daniel KIM, Seoul (KR)

(72) Inventor: Daniel KIM, Seoul (KR)

(21) Appl. No.: 19/005,357

(22) Filed: Dec. 30, 2024

(30) Foreign Application Priority Data
Feb. 20, 2024 (KR) 10-2024-0024408
Apr. 29, 2024 (KR) 10-2024-0057007

(51) Int. Cl. G08B 7/06; G06V 20/52; G06V 40/20; G08B 25/10; H04W 4/029; H04W 4/90

(52) U.S. Cl. CPC G08B 7/066; G06V 20/52; G06V 40/20; G08B 25/10; H04W 4/029; H04W 4/90

(57) ABSTRACT

A crime and emergency management system helps people find safety during emergencies. It uses GPS to locate people in trouble and then finds the nearest shelter. The system then calculates the safest route to that shelter and sends directions to the person's phone. This helps people quickly and efficiently evacuate to safety during a crisis.

### CROSS-REFERENCE TO RELATED APPLICATION

This application claims priority from Korean Patent Application No. 10-2024-0024408 filed on Feb. 20, 2024 and Korean Patent Application No. 10-2024-0057007 filed on Apr. 29, 2024 in the Korean Intellectual Property Office, and all the benefits accruing there from under 35 U.S.C. 119, the contents of which in its entirety are herein incorporated by reference.

### BACKGROUND

### Field

The present disclosure relates to a crime and emergency management system with crime prevention and evacuation functions. More specifically, the present disclosure relates to a crime and emergency management system having crime prevention and evacuation functions that provides a real-time evacuation guidance to a victim having an emergency situation due to a crime occurring in an external space such that the victim immediately evacuates to an adjacent safety shelter to effectively reduce crime damage.

### Description of Related Art

Various crimes such as kidnapping, violence, robbery, and murder occur regardless of whether the crime occurs in a public place or not. To prevent such crimes, crime prevention agents have been increased in jurisdictions, Crime Prevention Through Environmental Design (CPTED) measures have been implemented, or associated crime prevention cameras have been installed in various places to prevent and monitor crimes.

In this regard, a conventional crime prevention and surveillance system using crime prevention cameras in the context of the crime prevention through environmental design (CPTED) monitors images captured by the crime prevention cameras and stores the captured images therein on a time basis. Therefore, when a crime occurs, the conventional crime prevention and surveillance system may analyze the stored image and monitor the crime occurrence, thereby lowering the crime occurrence. Furthermore, various means (mobile phones, emergency bells, etc.) to notify emergency situations may be employed in the system.

However, the above-mentioned system has limitations in its role in actively blocking crimes. Moreover, the C3 system has limitations in reporting methods because a victim or witness related to the crime should contact a public safety reporting agency in the C3 system. In addition, in the C3 system, the crime may only be reported after a certain period of time has elapsed after the crime occurrence, such that late reporting makes it difficult to apprehend the criminal and reduces the effectiveness of crime prevention.

Furthermore, the biggest problem with these conventional approaches is that when an emergency crime occurs, everything is happening in real time. This means that there is a high probability that a crime will occur. The current reality is that the conventional approach is merely a means of apprehending the crime after a crime has occurred, and it is difficult to fundamentally block the crime, and to safely protect the crime victim in the conventional approach.

Generally, when an emergency situation in which the victim is harmed by the criminal in an external space such as a road occurs, the victim flees to another location to run away from the criminal and asks for help from people around him/her, or hides inside a nearby building or in a structure along the road side. Then, the victim may report the emergency situation to a public safety agency. However, there is a high possibility that this approach will not be able to prevent crimes in advance, and this approach cannot actually prevent damage due to the occurrence of the crime.

### PRIOR ART LITERATURE

Patent Document: Korean Patent No. 10-1399185 (registration date: May 19, 2014)

### SUMMARY

Accordingly, in recent years, there is a need for the development of a system in which when an emergency situation occurs, the victim is guided in real time to evacuate to a nearby safety shelter among the safety shelters, and the victim's movement is monitored in real time to enable safe evacuation based on the monitor in result.

Therefore, the present disclosure has been designed to solve the above-mentioned problems.

A purpose of the present disclosure is to provide a crime and emergency management system having crime prevention and evacuation functions that provides a real-time evacuation guidance to a victim having an emergency situation due to a crime occurring in an external space such that the victim immediately evacuates to an adjacent safety shelter to effectively reduce crime damage.

Furthermore, a purpose of the present disclosure is to provide a crime and emergency management system having crime prevention and evacuation functions which provides the victim to an evacuation path to a safe shelter, and tracks the victim's movement along the evacuation path in real time, and monitors in real time occurrence of an additional emergency situation as the victim moves along the evacuation path.

Furthermore, a purpose of the present disclosure is to provide a crime and emergency management system having crime prevention and evacuation functions in which when an emergency situation occurs on the victim, the system may transmit the emergency situation to a public safety agency server or a medical institution server adjacent to the victim, and monitors whether the victim moves safely along the evacuation path, based on image information acquired from cameras that may monitor the evacuation path, and upon determination that an additional emergency situation occurs on the evacuation path, the system may further transmit accurate information about the additional emergency situation to the medical institution server or the public safety agency server to immediately resolve or cope with the emergency situation.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

One aspect of the present disclosure provides a crime and emergency management system with crime prevention and evacuation functions, the crime and emergency management system comprising: a shelter position information storage in which position information of shelters are stored; an emergency shelter position information setting unit configured to: receive an emergency signal from a wireless communication device of a victim having an emergency in a wireless communication manner; recognize position information of the wireless communication device of the victim having transmitted the emergency signal based on GPS (Global Positioning System); select position information of a shelter adjacent to the recognized position information of the wireless communication device of the victim from among the position information of the shelters stored in the shelter position information storage; and set the selected position information as emergency shelter position information; an emergency movement path calculating unit configured to calculate an emergency movement path from the position information of the wireless communication device of the victim to the set emergency shelter position information; and an emergency movement path transmitting unit configured to transmit the calculated emergency movement path to the wireless communication device of the victim.

In accordance with some embodiments of the crime and emergency management system of the present disclosure, the crime and emergency management system further comprises: surveillance cameras arranged along the calculated emergency movement path; and a movement monitoring unit connected to the surveillance cameras in a wireless communication manner, wherein while the wireless communication device of the victim moves along the calculated emergency movement path, the surveillance cameras acquire images of the moving victim in real time and transmit the images to the movement monitoring unit, wherein the movement monitoring unit is configured to determine, based on the images of the victim acquired in real time, whether the victim is present in the calculated emergency movement path, wherein upon determination based on the images of the victim acquired in real time that the victim is present in the calculated emergency movement path, the movement monitoring unit is configured to determine that the victim is in a safe state, wherein upon determination based on the image of the victim acquired in real time that the victim is absent in the calculated emergency movement path, the movement monitoring unit is configured to determine that the victim is in a damaged state, wherein the movement monitoring unit is configured to identify a first position of a surveillance camera capturing an image on which the victim is absent for the first time, from among the surveillance cameras arranged in the calculated emergency movement path, based on based on the images of the victim acquired in real time, wherein the movement monitoring unit is configured to identify a second position of a surveillance camera capturing an image on which the victim is present and located just before the first position in the emergency movement path, from among the surveillance cameras arranged in the calculated emergency movement path, based on based on the images of the victim acquired in real time, wherein the movement monitoring unit is configured to designate a path connecting the first and second positions to each other as an emergency path, wherein the movement monitoring unit is configured to transmit the designated emergency path, position information of the wireless communication device of the victim on the designated emergency path, and the image acquired at each of the first and second positions to a public safety agency server in a wireless communication manner.

In accordance with some embodiments of the crime and emergency management system of the present disclosure, the crime and emergency management system further comprises a variable movement information receiving unit and an additional emergency occurrence determination unit, wherein after the calculated emergency movement path is transmitted to the wireless communication device of the victim, the position information of the wireless communication device of the victim is variable such that movement information of the wireless communication device of the victim is variable, wherein the variable movable information receiving unit is configured to receive the variable movement information of the wireless communication device of the victim in real time from the wireless communication device of the victim, wherein the additional emergency occurrence determination unit is configured to: determine whether the received variable movement information of the wireless communication device of the victim coincides with the emergency movement path; and upon determination that the received variable movement information of the wireless communication device of the victim does not coincide with the emergency movement path, determine that an additional emergency has occurred.

In accordance with some embodiments of the crime and emergency management system of the present disclosure, the additional emergency occurrence determination unit is configured to transmit the position information of the wireless communication device of the victim based on the GPS to the public safety agency server at a time point when the additional emergency situation occurs.

In accordance with some embodiments of the crime and emergency management system of the present disclosure, when the position information of the wireless communication device of the victim is not identified based on the GPS at the time point at which the additional emergency situation occurs, the additional emergency occurrence determination unit is configured to: set a circular area having a predetermined radius around a point where the additional emergency situation occurs as an additional emergency area; acquire additional images through other surveillance cameras disposed within the set additional emergency area; and transmit information about the set additional emergency area and the acquired additional images to the public safety agency server.

In accordance with some embodiments of the crime and emergency management system of the present disclosure, the crime and emergency management system further comprises a victim abnormal state determination unit, wherein the victim abnormal state determination unit is configured to: process the images acquired in real time from the surveillance cameras; calculate a moving speed of the victim based on a victim image included in the acquired images; upon determination that the calculated movement speed of the victim decreases to a preset abnormal speed or is calculated as 0, determine that the victim is in an abnormal state; and transmit abnormal state-related information to a medical institution server positioned within a set radius around a position of the victim at which the victim is determined to be in the abnormal state in a wireless communication manner, wherein the abnormal state-related information include: information based on which the victim abnormal state determination unit determines the victim to be in the abnormal state; and position information of the wireless communication device of the victim at a time point at which the victim abnormal state determination unit determines the victim to be in the abnormal state.

In accordance with some embodiments of the crime and emergency management system of the present disclosure, as soon as the medical institution server receives the abnormal state-related information from the victim abnormal state determination unit, the medical institution server is configured to the abnormal state-related information to the public safety agency server in a wireless communication manner.

In accordance with some embodiments of the crime and emergency management system of the present disclosure, when the emergency shelter position information setting unit has received the emergency signal from the wireless communication device of the victim in the wireless communication scheme, the emergency shelter position information setting unit is configured to forcibly operate an emergency notification module included in the wireless communication device of the victim in a remote control manner.

In accordance with some embodiments of the crime and emergency management system of the present disclosure, the crime and emergency management system further comprises shelters and a monitoring server, wherein each of the shelters is installed at a corresponding regional position, wherein each of the shelters includes: a shelter body having a shelter space having defined therein, and an entrance defined at a side surface of the shelter body; a door installed on the shelter body and configured to open and close the entrance; a driver configured to move the door; and a controller configured to control the driver, wherein the controller is configured to control the driver, upon receiving a remote control signal from the monitoring server, wherein when the position information of the wireless communication device of the victim is positioned within a set proximity distance from the emergency shelter position information, the monitoring server is configured to instruct the controller to control the driver to move the door of the shelter positioned in the emergency shelter position information so as to open the entrance, wherein when the position information of the wireless communication device of the victim has reached the shelter space of the shelter body, the monitoring server is configured to instruct the controller to control the driver to move the door of the shelter positioned in the emergency shelter position information to close the entrance.

In accordance with some embodiments of the crime and emergency management system of the present disclosure, an air-filled member filled with air by an air filler is disposed on an inner surface and an outer surface of each of the shelter body and the door, wherein a shock sensor is disposed on the shelter body and the door to detect an external impact force, wherein upon determination that, in a state in which the position information of the wireless communication device of the victim has reached the shelter space of the shelter body such that the door has been forcibly closed, the detected external impact force exceeds an emergency impact force set in the controller, the monitoring server is configured to: transmit information indicating that a criminal can invade into the shelter to the public safety agency server in a wireless communication manner; and control a speaker provided on the shelter to output an emergency indicating sound to an outside.

The technical solutions according to an embodiment of the present disclosure are not limited to those as mentioned above. Other technical solutions not mentioned above may be clearly understood by those skilled in the art from following descriptions set forth below.

The crime and emergency management system having crime prevention and evacuation functions according to the present disclosure may provide a real-time evacuation guidance to the victim having an emergency situation due to a crime occurring in an external space such that the victim immediately evacuates to an adjacent safety shelter to effectively reduce crime damage.

Furthermore, the crime and emergency management system having crime prevention and evacuation functions according to the present disclosure may provide the victim to an evacuation path to a safe shelter, and track the victim's movement along the evacuation path in real time, and monitor in real time occurrence of the additional emergency situation as the victim moves along the evacuation path.

Furthermore, when the emergency situation occurs on the victim the crime, the emergency management system having crime prevention and evacuation functions according to the present disclosure may transmit the emergency situation to the public safety agency server or the medical institution server adjacent to the victim, and monitor whether the victim moves safely along the evacuation path, based on image information acquired from cameras that may monitor the evacuation path. Further, upon determination that the additional emergency situation occurs on the evacuation path, the system may further transmit accurate information about the additional emergency situation to the medical institution server or the public safety agency server to immediately resolve or cope with the emergency situation.

Effects of the present disclosure are not limited to the effects mentioned above, and other effects not mentioned will be clearly understood by those skilled in the art from the description below.

In addition to the above effects, specific effects of the present disclosure are described together while describing specific details for carrying out the present disclosure.

### BRIEF DESCRIPTION OF DRAWINGS

FIG. 1 is a block diagram showing a crime and emergency management system with crime prevention and evacuation functions in accordance with the present disclosure.

FIG. 2 is a block diagram showing an example of a crime and emergency management system further including a movement monitoring unit according to the present disclosure.

FIG. 3 is a block diagram showing an example of a crime and emergency management system further including a variable movement information receiving unit and an additional emergency occurrence determination unit according to the present disclosure.

FIG. 4 is a block diagram showing an operation of a crime and emergency management system further including a variable movement information receiving unit and an additional emergency occurrence determination unit according to the present disclosure.

FIG. 5 is a block diagram showing an example of a crime and emergency management system further including a victim abnormal state determination unit according to the present disclosure.

FIG. 6 is a block diagram showing a configuration in which the crime and emergency management system according to the present disclosure operates an emergency notification module in a remote manner.

FIG. 7 is a drawing showing an example of a configuration of a shelter according to the present disclosure.

FIG. 8 is a block diagram showing an example of a crime and emergency management system further including a monitoring server according to the present disclosure.

FIG. 9 is a diagram showing an example in which a crime and emergency management system according to the present disclosure suppresses occurrence of an additional crime.

FIG. 10 is a block diagram showing an operation of a crime and emergency management system further including a drone flight control unit according to the present disclosure.

### DETAILED DESCRIPTIONS

Advantages and features of the present disclosure, and a method of achieving the advantages and features will become apparent with reference to embodiments described later in detail together with the accompanying drawings. However, the present disclosure is not limited to the embodiments as disclosed under, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

A shape, a size, a ratio, an angle, a number, etc. disclosed in the drawings for illustrating embodiments of the present disclosure are illustrative, and the present disclosure is not limited thereto.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements may modify the entire list of elements and may not modify the individual elements of the list. In interpretation of numerical values, an error or tolerance therein may occur even when there is no explicit description thereof.

In addition, it will also be understood that when a first element or layer is referred to as being present “on” a second element or layer, the first element may be disposed directly on the second element or may be disposed indirectly on the second element with a third element or layer being disposed between the first and second elements or layers. It will be understood that when an element or layer is referred to as being “connected to”, or “connected to” another element or layer, it may be directly on, connected to, or connected to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

In descriptions of temporal relationships, for example, temporal precedent relationships between two events such as “after”, “subsequent to”, “before”, etc., another event may occur there between unless “directly after”, “directly subsequent” or “directly before” is not indicated.

When a certain embodiment may be implemented differently, a function or an operation specified in a specific block may occur in a different order from an order specified in a flowchart. For example, two blocks in succession may be actually performed substantially concurrently, or the two blocks may be performed in a reverse order depending on a function or operation involved.

It will be understood that, although the terms “first”, “second”, “third”, and so on may be used herein to describe various elements, components, regions, layers and/or periods, these elements, components, regions, layers and/or periods should not be limited by these terms. These terms are used to distinguish one element, component, region, layer or section from another element, component, region, layer or period. Thus, a first element, component, region, layer or section as described under could be termed a second element, component, region, layer or period, without departing from the spirit and scope of the present disclosure.

When an embodiment may be implemented differently, functions or operations specified within a specific block may be performed in a different order from an order specified in a flowchart. For example, two consecutive blocks may actually be performed substantially simultaneously, or the blocks may be performed in a reverse order depending on related functions or operations.

The features of the various embodiments of the present disclosure may be partially or entirely combined with each other, and may be technically associated with each other or operate with each other. The embodiments may be implemented independently of each other and may be implemented together in an association relationship.

It will be understood that when an element or layer is referred to as being “connected to”, or “connected to” another element or layer, it may be directly on, connected to, or connected to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, “embodiments,” “examples,” “aspects, and the like should not be construed such that any aspect or design as described is superior to or advantageous over other aspects or designs.

Further, the term ‘or’ means ‘inclusive or’ rather than ‘exclusive or’. That is, unless otherwise stated or clear from the context, the expression that ‘x uses a or b’ means any one of natural inclusive permutations.

The terms used in the description below have been selected as being general and universal in the related technical field. However, there may be other terms than the terms depending on the development and/or change of technology, convention, preference of technicians, etc. Therefore, the terms used in the description below should not be understood as limiting technical ideas, but should be understood as examples of the terms for illustrating embodiments.

Further, in a specific case, a term may be arbitrarily selected by the applicant, and in this case, the detailed meaning thereof will be described in a corresponding description period. Therefore, the terms used in the description below should be understood based on not simply the name of the terms, but the meaning of the terms and the contents throughout the Detailed Descriptions.

In description of flow of a signal, for example, when a signal is delivered from a node A to a node B, this may include a case where the signal is transferred from the node A to the node B via another node unless a phrase ‘immediately transferred’ or ‘directly transferred’ is used.

A crime prevention and evacuation application in accordance with the present disclosure will be described with reference to the attached drawings.

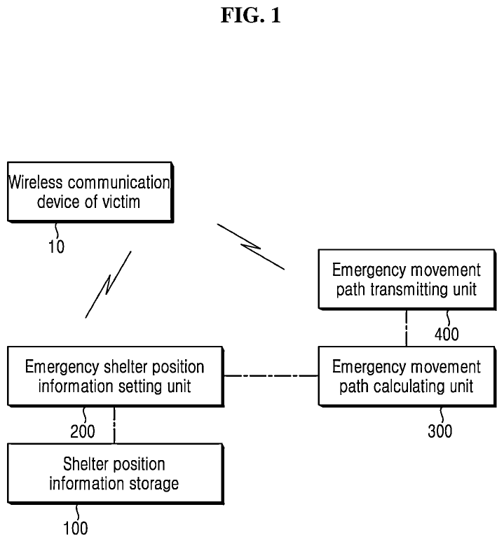

FIG. 1 is a block diagram showing a crime and emergency management system with crime prevention and evacuation functions in accordance with the present disclosure.

Referring to FIG. 1, the crime and emergency management system with crime prevention and evacuation functions in accordance with the present disclosure includes a shelter position information storage 100 in which position information of shelters are stored; an emergency shelter position information setting unit 200 configured to: receive an emergency signal from a wireless communication device 10 of a victim having an emergency in a wireless communication manner; recognize position information of the wireless communication device 10 of the victim having transmitted the emergency signal based on GPS (Global Positioning System); select position information of a shelter adjacent to the recognized position information of the wireless communication device of the victim from among the position information of the shelters stored in the shelter position information storage; and set the selected position information as emergency shelter position information; an emergency movement path calculating unit 300 configured to calculate an emergency movement path from the position information of the wireless communication device 10 of the victim to the set emergency shelter position information; and an emergency movement path transmitting unit 400 configured to transmit the calculated emergency movement path to the wireless communication device 10 of the victim.

In one example, the wireless communication device 10 of the victim may include a user device such as a smart phone, a mobile phone, a lap top computer, etc.

A configuration and an operation of the crime and emergency management system with crime prevention and evacuation functions will be described in details.

The shelter position information storage 100 may store therein the position information of shelters.

The emergency shelter position information setting unit 200 may include an emergency signal receiving unit (not shown), a victim wireless communication device position information recognition unit (not shown), a shelter selection unit (not shown), and a setting unit (not shown).

The emergency signal receiving unit of the emergency shelter position information setting unit 200 receives an emergency signal from the wireless communication device 10 of the victim having the emergency situation using a wireless communication scheme.

The victim wireless communication device position information recognition unit of the emergency shelter position information setting unit 200 recognizes the position information of the wireless communication device 10 of the victim that has transmitted the emergency signal based on the GPS.

The shelter selection unit of the emergency shelter position information setting unit 200 selects position information of a shelter adjacent to the recognized position information of the wireless communication device of the victim from among the position information of the shelters stored in the shelter position information storage 100.

The setting unit of the shelter selection unit of the emergency shelter position information setting unit 200 sets the selected position information as emergency shelter position information.

The emergency movement path calculating unit 300 calculates the optimal emergency movement path based on the victim wireless communication device position information and the set emergency shelter position information. That is, the emergency movement path calculating unit 300 is configured to calculate an emergency movement path from the position information of the wireless communication device 10 of the victim to the set emergency shelter position information. The calculated path may be designed to avoid crime occurrence areas and risk factors in consideration of safety.

The emergency movement path transmitting unit 400 transmits the calculated emergency movement path to the wireless communication device 10 of the victim.

The wireless communication device 10 of the victim may include an interface through which the victim may check emergency situation information, the shelter information, the emergency movement path, etc.

An operation of the crime and emergency management system according to the present disclosure will be described.

When the victim is in an emergency situation, an emergency app (program) pre-installed on the wireless communication device 10 of the victim may be executed such that the wireless communication device 10 of the victim transmits the emergency signal to the emergency signal receiving unit of the emergency shelter position information setting unit 200 in a wireless communication scheme.

The emergency signal receiving unit receives the emergency signal. The victim wireless communication device position information recognition unit of the emergency shelter position information setting unit 200 recognizes the position information of the wireless communication device 10 of the victim based on the GPS.

The selection unit of the emergency shelter position information setting unit 200 may select the nearest shelter from the position information of the wireless communication device 10 of the victim. The setting unit of the emergency shelter position information setting unit 200 may set the position information of the selected shelter as the emergency shelter position information.

The emergency movement path calculating unit 300 calculates the optimal emergency movement path based on the position information of the wireless communication device 10 of the victim and the emergency shelter position information.

The emergency movement path transmitting unit 400 transmits the calculated emergency movement path to the wireless communication device 10 of the victim.

The victim may check emergency situation information, the shelter information, the emergency movement path, etc. through a user interface and may safely move to the shelter along the emergency movement path.

Accordingly, the crime and emergency management system according to the present disclosure may support safe evacuation by receiving the victim's emergency signal in real time and providing the optimal evacuation path or the emergency movement path.

Furthermore, the crime and emergency management system according to the present disclosure may provide a personalized evacuation path based on the victim's current position, surrounding environment around the victim, crime occurrence status, etc.

Furthermore, the crime and emergency management system according to the present disclosure may provide an evacuation path having increased safety by removing crime occurrence areas and risk factors from the emergency movement path.

Furthermore, the crime and emergency management system according to the present disclosure may provide a user-friendly interface so as to be used quickly and easily in emergency situations.

In addition, the crime and emergency management system according to the present disclosure may help prevent crime by providing information on a crime occurrence region, and crime prevention tips.

Furthermore, the crime and emergency management system according to the present disclosure may provide information about emergency situations such as crime occurrence information and disaster occurrence information, and may provide a contact function with emergency organizations such as police, fire stations, and hospitals.

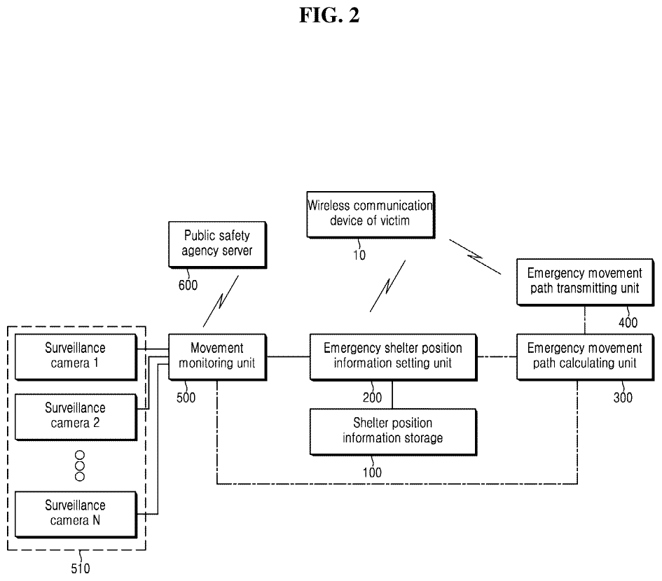

FIG. 2 is a block diagram showing an example in which a crime and emergency management system according to the present disclosure further includes a movement monitoring unit.

Referring to FIG. 2, the crime and emergency management system in accordance with the present disclosure includes surveillance cameras 510 arranged along the calculated emergency movement path and a movement monitoring unit 500 connected to the surveillance cameras 510 in a wireless communication scheme.

In this regard, when the wireless communication device 10 of the victim moves along the calculated emergency movement path, the surveillance cameras 510 acquire images of the moving victim in real time and transmit the images to the movement monitoring unit 500.

Next, the movement monitoring unit 500 determines, based on the images of the victim acquired in real time, whether the victim is present in the calculated emergency movement path.

Upon determination based on the images of the victim acquired in real time that the victim is present in the calculated emergency movement path, the movement monitoring unit 500 recognizes this state as a safe state. However, upon determination based on the image of the victim acquired in real time that the victim is absent in the calculated emergency movement path, the movement monitoring unit 500 recognizes this state as a damaged state.

In this regard, the movement monitoring unit 500 may identify a first position of a surveillance camera 510 capturing an image on which the victim is absent for the first time, from among the surveillance cameras 510 arranged in the calculated emergency movement path, based on based on the images of the victim acquired in real time.

Further, the movement monitoring unit 500 may identify a second position of a surveillance camera 510 capturing an image on which the victim is present and located just before the first position in the emergency movement path, from among the surveillance cameras 510 arranged in the calculated emergency movement path, based on based on the images of the victim acquired in real time.

Then, the movement monitoring unit 500 may designate a path connecting the first and second positions to each other as an emergency path, and may transmit the designated emergency path, position information of the wireless communication device 10 of the victim on the designated emergency path, and the image acquired at each of the first and second positions to a public safety agency server 600 in a wireless communication manner.

The crime and emergency management system as shown in FIG. 2 further includes the movement monitoring unit 500 to addition to the components of the crime and emergency management system in FIG. 1 to more effectively secure the victim's safety.

The movement monitoring unit 500 according to the present disclosure is connected to surveillance cameras 510 arranged along the calculated emergency movement path in a wireless communication manner. When the wireless communication device 10 of the victim moves along the calculated emergency movement path, the surveillance cameras 510 acquire images of the moving victim in real time and transmit the images to the movement monitoring unit 500.

The movement monitoring unit 500 determines whether the victim exists in the calculated emergency movement path, based on the images of the victim acquired in real time.

Upon determination based on the images of the victim acquired in real time that the victim is present in the calculated emergency movement path, the movement monitoring unit 500 recognizes this state as a safe state.

However, upon determination based on the image of the victim acquired in real time that the victim is absent in the calculated emergency movement path, the movement monitoring unit 500 recognizes this state as a damaged state.

Furthermore, the movement monitoring unit 500 transmits information about the victim recognized as being in the damaged state to the public safety agency server 600. The public safety agency server may quickly rescue the victim based on the victim's position information and the emergency path information.

An operation of the emergency management system as shown in FIG. 2 will be described in a more specific manner.

When the victim is in an emergency situation, an emergency app (program) pre-installed on the wireless communication device 10 of the victim may be executed such that the wireless communication device 10 of the victim transmits the emergency signal to the emergency signal receiving unit of the emergency shelter position information setting unit 200 in a wireless communication scheme.

The emergency signal receiving unit receives the emergency signal. The victim wireless communication device position information recognition unit of the emergency shelter position information setting unit 200 recognizes the position information of the wireless communication device 10 of the victim based on the GPS.

The selection unit of the emergency shelter position information setting unit 200 may select the nearest shelter from the position information of the wireless communication device 10 of the victim. The setting unit of the emergency shelter position information setting unit 200 may set the position information of the selected shelter as the emergency shelter position information.

The emergency movement path calculating unit 300 calculates the optimal emergency movement path based on the position information of the wireless communication device 10 of the victim and the emergency shelter position information.

The emergency movement path transmitting unit 400 transmits the calculated emergency movement path to the wireless communication device 10 of the victim.

The victim may check emergency situation information, the shelter information, the emergency movement path, etc. through a user interface and may safely move to the shelter along the emergency movement path.

When the wireless communication device of the victim 10 moves along the calculated emergency movement path, the surveillance cameras acquire images of the moving victim in real time and transmit the images to the movement monitoring unit.

Next, the movement monitoring unit 500 determines, based on the images of the victim acquired in real time, whether the victim is present in the calculated emergency movement path.

Upon determination based on the images of the victim acquired in real time that the victim is present in the calculated emergency movement path, the movement monitoring unit 500 recognizes this state as a safe state. However, upon determination based on the image of the victim acquired in real time that the victim is absent in the calculated emergency movement path, the movement monitoring unit 500 recognizes this state as a damaged state.

In this regard, the movement monitoring unit 500 may identify the first position of a surveillance camera 510 capturing an image on which the victim is absent for the first time, from among the surveillance cameras 510 arranged in the calculated emergency movement path, based on based on the images of the victim acquired in real time.

Further, the movement monitoring unit 500 may identify the second position of a surveillance camera 510 capturing an image on which the victim is present and located just before the first position in the emergency movement path, from among the surveillance cameras 510 arranged in the calculated emergency movement path, based on based on the images of the victim acquired in real time.

Then, the movement monitoring unit 500 may designate a path connecting the first and second positions to each other as an emergency path, and may transmit the designated emergency path, position information of the wireless communication device 10 of the victim on the designated emergency path, and the image acquired at each of the first and second positions to the public safety agency server 600 in a wireless communication manner.

The public safety agency server 600 allows the victim to be quickly rescued based on the victim's position information and the emergency path information.

The crime and emergency management system of FIG. 2 according to the present disclosure may more effectively secure the safety of the victim and effectively shorten a time for which the public safety agency copes with the crime and the emergency.

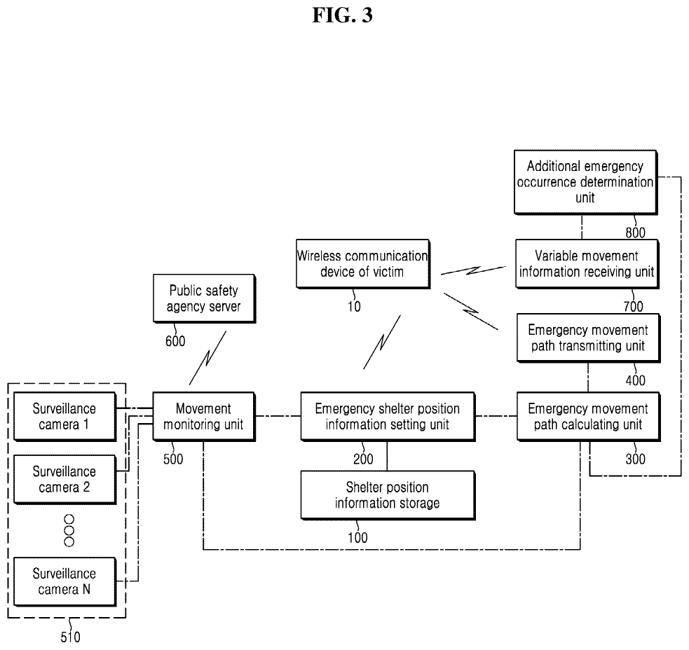

FIG. 3 is a block diagram showing an example in which a crime and emergency management system according to the present disclosure further include a variable movement information receiving unit and an additional emergency occurrence determination unit.

Referring to FIG. 3, the crime and emergency management system according to the present disclosure further includes a variable movement information receiving unit 700 and an additional emergency occurrence determination unit 800.

After the calculated emergency movement path is transmitted to the wireless communication device 10 of the victim, the position information of the wireless communication device 10 of the victim may be variable such that movement information of the wireless communication device 10 may be variable. Thus, the variable movement information receiving unit 700 receives variable movement information of the wireless communication device 10 in real time from the wireless communication device 10 of the victim.

The additional emergency occurrence determination unit 800 determines whether the received variable movement information of the wireless communication device 10 of the victim coincides with the emergency movement path. When it is determined that the received variable movement information of the wireless communication device of the victim does not coincide with the emergency movement path, the additional emergency occurrence determination unit 800 may determine that an additional emergency situation has occurred.

FIG. 3 shows an example in which the victim's safety is further strengthened by adding the variable movement information receiving unit and the additional emergency occurrence determination unit 800 to the crime and emergency management system of each of FIG. 1 and FIG. 2.

The variable movable information receiving unit 700 receives the position information changed in real time whenever the position information of the wireless communication device 10 of the victim changes.

The additional emergency occurrence determination unit 800 determines whether the received variable movement information coincides with the emergency movement path. When it is determined that the received variable movement information of the wireless communication device of the victim does not coincide with the emergency movement path, the additional emergency occurrence determination unit 800 may determine that an additional emergency situation has occurred.

An operation of the crime and emergency management system according to the present disclosure further including the variable movement information receiving unit 700 and the additional emergency occurrence determination unit 800 will be described.

When the victim is in an emergency situation, an emergency app (program) pre-installed on the wireless communication device 10 of the victim may be executed such that the wireless communication device 10 of the victim transmits the emergency signal to the emergency signal receiving unit of the emergency shelter position information setting unit 200 in a wireless communication scheme.

The emergency signal receiving unit receives the emergency signal. The victim wireless communication device position information recognition unit of the emergency shelter position information setting unit 200 recognizes the position information of the wireless communication device 10 of the victim based on the GPS.

The selection unit of the emergency shelter position information setting unit 200 may select the nearest shelter from the position information of the wireless communication device 10 of the victim. The setting unit of the emergency shelter position information setting unit 200 may set the position information of the selected shelter as the emergency shelter position information.

The emergency movement path calculating unit 300 calculates the optimal emergency movement path based on the position information of the wireless communication device 10 of the victim and the emergency shelter position information.

The emergency movement path transmitting unit 400 transmits the calculated emergency movement path to the wireless communication device 10 of the victim.

The victim may check emergency situation information, the shelter information, the emergency movement path, etc. through a user interface and may safely move to the shelter along the emergency movement path.

After the calculated emergency movement path is transmitted to the wireless communication device 10 of the victim, the position information of the wireless communication device 10 of the victim may be variable such that movement information of the wireless communication device 10 may be variable. Thus, the variable movement information receiving unit 700 receives variable movement information of the wireless communication device 10 in real time from the wireless communication device 10 of the victim.

The additional emergency occurrence determination unit 800 determines whether the received variable movement information of the wireless communication device 10 of the victim coincides with the emergency movement path. When it is determined that the received variable movement information of the wireless communication device of the victim does not coincide with the emergency movement path, the additional emergency occurrence determination unit 800 may determine that an additional emergency situation has occurred.

The additional emergency occurrence determination unit 800 transmit a notification of the occurrence of the additional emergency situation to the public safety agency server 600.

The public safety agency server 600 may receive the notification and quickly rescue the victim based on the position information of the victim and the situation information.

The crime and emergency management system according to the present disclosure may track the victim's movement path in real time so that the public safety agency server 60 may quickly cope with the emergency situation.

This embodiment may be applied to a real-life as follows. The victim moves along the emergency movement path, and then suddenly changes a movement direction there from and moves along a different path there from. In this case, the additional emergency occurrence determination unit 800 determines that an additional emergency situation has occurred and transmits the notification of the occurrence of the additional emergency situation to the public safety agency server 600.

Furthermore, when the victim falls down or loses consciousness in the middle of the emergency movement path and cannot further move, the variable movement information receiving unit 700 may no longer receive the variable movement information from the wireless communication device 10 of the victim. In this case, the additional emergency occurrence determination unit 800 may determine that the victim is in an emergency situation and transmit a notification thereof to the public safety agency server 600.

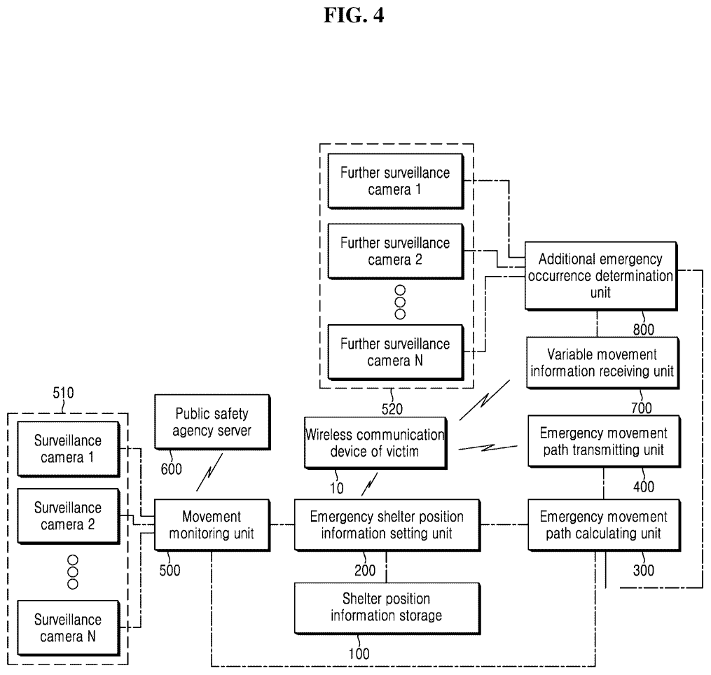

FIG. 4 is a block diagram showing an operation of the additional emergency occurrence determination unit 800 according to the present disclosure.

Referring to FIG. 4, the additional emergency occurrence determination unit 800 according to the present disclosure transmits the position information of the wireless communication device 10 of the victim based on the GPS to the public safety agency server 600 at the time point when the additional emergency situation occurs.

Furthermore, when the position information of the wireless communication device 10 of the victim based on the GPS is not identified at the time at which the additional emergency situation occurs, the additional emergency occurrence determination unit 800 sets a circle having a preset radius around a point where the additional emergency situation occurs as an additional emergency area.

Then, the additional emergency occurrence determination unit 800 acquires additional images through other surveillance cameras 520 included in the set additional emergency area and transmits information about the set additional emergency area and the acquired additional images to the public safety agency server 600.

Under the above configuration, when the wireless communication device 10 of the victim deviates from the emergency movement path or the variable movement information receiving unit 700 no longer receives the variable movement information, the additional emergency occurrence determination unit 800 determines that an additional emergency situation has occurred.

The additional emergency occurrence determination unit 800 transmits following information to the public safety agency server 600:
The emergency occurrence time point at which the additional emergency situation occurs;
the victim wireless communication device position information, wherein the victim wireless communication device position information may be position information of the victim wireless communication device identified based on the GPS (if available);
the additional emergency area as a circular are a having the preset radius set based on the position information of the wireless communication device 10 of the victim (if the victim wireless communication device position information cannot be identified); and
the additional image as an image acquired from other surveillance cameras 520 included within an additional emergency area.

The above configuration may be applied to an actual example as follows.

When the victim moves along the emergency movement path and then suddenly changes a direction thereof from the emergency movement path and moves along a path different there from, the additional emergency occurrence determination unit 800 determines that an additional emergency situation has occurred and sends a notification thereof to the public safety agency server 600.

The public safety agency server 600 searches for the victim based on the victim's last position information and the additional emergency area information.

When the victim falls down or loses consciousness in the middle of the emergency movement path and cannot move, the variable movement information receiving unit 700 may no longer receive the variable movement information from the wireless communication device 10 of the victim.

In this case, the additional emergency occurrence determination unit 800 may determine that an additional emergency situation has occurred and transmit a notification thereof to the public safety agency server 600. The public safety agency server 600 may set an additional emergency area based on the victim's last position information and may find the victim through surveillance cameras within the set additional emergency area.

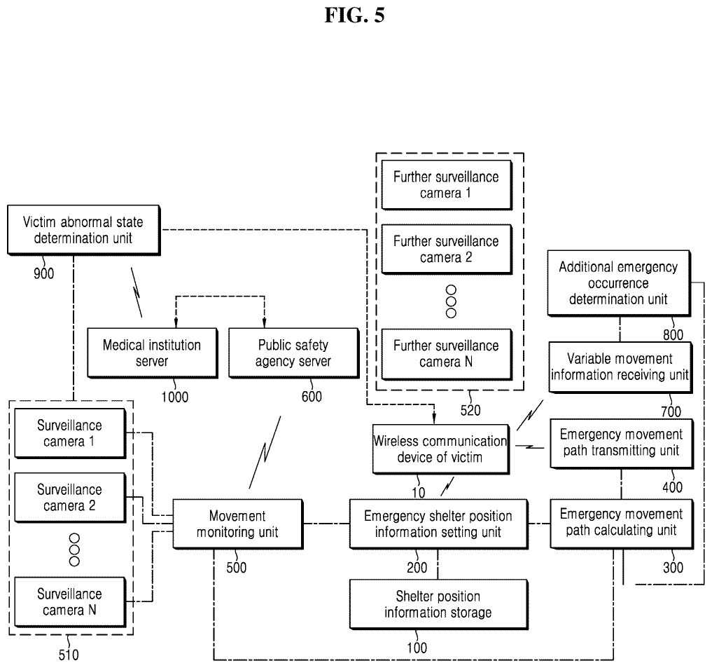

FIG. 5 is a block diagram showing an example in which the crime and emergency management system according to the present disclosure further includes a victim abnormal state determination unit.

Referring to FIG. 5, the crime and emergency management system according to the present disclosure further includes a victim abnormal state determination unit 900.

The victim abnormal state determination unit 900 may process images acquired in real time from the surveillance cameras 510.

Next, the victim abnormal state determination unit 900 calculates a moving speed of the victim based on a victim image included in the acquired image.

When the calculated moving speed of the victim decreases to a preset abnormal speed or when the calculated moving speed of the victim is calculated as 0, the victim abnormal state determination unit 900 determines the victim to be in an abnormal state.

The victim abnormal state determination unit 900 may transmit following information to a medical institution server 1000 positioned within a set radius around apposition of the victim determined to be in the abnormal state in a wireless communication manner:
the information based on which the victim abnormal state determination unit 900 determines the victim to be in the abnormal state; and
the position information of the wireless communication device 10 of the victim at the point in time at which the victim abnormal state determination unit 900 determines the victim to be in the abnormal state.

An operation of the emergency management system further including the victim abnormal state determination unit 900 as shown in FIG. 5 will be described in a more specific manner.

When the victim is in an emergency situation, an emergency app (program) pre-installed on the wireless communication device 10 of the victim may be executed such that the wireless communication device 10 of the victim transmits the emergency signal to the emergency signal receiving unit of the emergency shelter position information setting unit 200 in a wireless communication scheme.

The emergency signal receiving unit receives the emergency signal. The victim wireless communication device position information recognition unit of the emergency shelter position information setting unit 200 recognizes the position information of the wireless communication device 10 of the victim based on the GPS.

The selection unit of the emergency shelter position information setting unit 200 may select the nearest shelter from the position information of the wireless communication device 10 of the victim. The setting unit of the emergency shelter position information setting unit 200 may set the position information of the selected shelter as the emergency shelter position information.

The emergency movement path calculating unit 300 calculates the optimal emergency movement path based on the position information of the wireless communication device 10 of the victim and the emergency shelter position information.

The emergency movement path transmitting unit 400 transmits the calculated emergency movement path to the wireless communication device 10 of the victim.

The victim may check emergency situation information, the shelter information, the emergency movement path, etc. through a user interface and may safely move to the shelter along the emergency movement path.

When the wireless communication device of the victim 10 moves along the calculated emergency movement path, the surveillance cameras acquire images of the moving victim in real time and transmit the images to the movement monitoring unit.

Next, the movement monitoring unit 500 determines, based on the images of the victim acquired in real time, whether the victim is present in the calculated emergency movement path.

Upon determination based on the images of the victim acquired in real time that the victim is present in the calculated emergency movement path, the movement monitoring unit 500 recognizes this state as a safe state. However, upon determination based on the image of the victim acquired in real time that the victim is absent in the calculated emergency movement path, the movement monitoring unit 500 recognizes this state as a damaged state.

In this regard, the movement monitoring unit 500 may identify the first position of a surveillance camera 510 capturing an image on which the victim is absent for the first time, from among the surveillance cameras 510 arranged in the calculated emergency movement path, based on based on the images of the victim acquired in real time.

Further, the movement monitoring unit 500 may identify the second position of a surveillance camera 510 capturing an image on which the victim is present and located just before the first position in the emergency movement path, from among the surveillance cameras 510 arranged in the calculated emergency movement path, based on based on the images of the victim acquired in real time.

Then, the movement monitoring unit 500 may designate a path connecting the first and second positions to each other as an emergency path, and may transmit the designated emergency path, position information of the wireless communication device 10 of the victim on the designated emergency path, and the image acquired at each of the first and second positions to the public safety agency server 600 in a wireless communication manner.

The public safety agency server 600 allows the victim to be quickly rescued based on the victim's position information and the emergency path information.

While the wireless communication device 10 of the victim moves, surveillance cameras 510 acquire images of the moving victim in real time and transmit the images to the victim abnormal state determination unit 900.

The victim abnormal state determination unit 900 calculates the moving speed of the victim based on the acquired images.

When the victim's movement speed decreases to a preset abnormal speed or is calculated as 0, the victim abnormal state determination unit 900 determines that the victim is in the victim abnormal state.

The victim abnormal state determination unit 900 may transmit following information to the medical institution server 1000 positioned within a set radius around a position of the victim determined to be in the abnormal state in a wireless communication manner:
the information based on which the victim abnormal state determination unit 900 determines the victim to be in the abnormal state; and
the position information of the wireless communication device 10 of the victim at the point in time at which the victim abnormal state determination unit 900 determines the victim to be in the abnormal state.

The above configuration may be applied an actual example as follows. When the victim suddenly falls down or loses consciousness while moving along the emergency movement path and thus cannot move, the victim's movement speed is calculated as 0. The victim abnormal state determination unit 900 detects this state, and determines that the victim is in the abnormal state, and transmits a notification there of to the medical institution server 1000.

Furthermore, when the victim falls down after being attacked by a criminal, the victim's movement speed decreases drastically. The victim abnormal state determination unit 900 detects this situation, and determines that the victim is in the abnormal state, and sends a notification thereof to the public safety agency server 600 and the medical institution server 1000.

Accordingly, the crime and emergency management system according to the present disclosure may more effectively secure the victim's safety, and may shorten a time duration for which each of the public safety agency and the medical institution copes with the emergency situation. The crime and emergency management system according to the present disclosure may help prevent crime damage and save the victim's life.

Furthermore, as soon as the medical institution server 1000 receives the above information from the victim abnormal state determination unit 900, the medical institution server 1000 may transmit the received information to the public safety agency server 600 in a wireless communication manner.

As described above, the received information may include the information based on which the victim abnormal state determination unit 900 determines the victim to be in the abnormal state; and the position information of the wireless communication device 10 of the victim at the point in time at which the victim abnormal state determination unit 900 determines the victim to be in the abnormal state.

The crime and emergency management system as shown in FIG. 5 may additionally provide a function of providing rapid medical support in association with the medical institution server 1000 when the victim abnormal state occurs. This may play a very important role in saving the victim's life.

The medical institution server 1000 takes the following actions based on the received information.

The medical institution server 1000 may send an emergency notification thereof to a wireless communication device of the nearest hospital or medical staff based on the victim's position information to request prompt dispatch thereto.

Furthermore, the medical institution server 1000 may prepare necessary medical resources in preparation for an emergency situation based on the victim's status information.

Furthermore, the medical institution server 1000 may communicate with the victim's family or acquaintances' wireless communication devices to inform the victim's family or acquaintances of the emergency situation and to request the victim's family or acquaintances to take necessary measures. This may be a case where permission to share contact information stored in the wireless communication device 10 of the victim has been obtained from the victim in advance.

Accordingly, the crime and emergency management system according to the present disclosure may increase the likelihood of saving the victim's life through prompt medical assistance.

Furthermore, the medical institution server 1000 according to the present disclosure may identify the victim's status information in advance and efficiently provide medical services based on the victim's status information.

Furthermore, the medical institution server 1000 according to the present disclosure may continuously inform the victim's family or acquaintances of the current situation to relieve anxiety thereof.

The above configuration may be applied to an actual example as follows. When the victim is attacked by a criminal and suffers serious injuries, the victim abnormal state determination unit 900 determines that the victim is in the abnormal state and transmits a notification there of to the medical institution server. The medical institution server 1000 may send a notification hereof to a nearby hospital closest to the victim to request prompt emergency treatment.

Furthermore, when the victim falls down due to a sudden illness such as a heart attack or stroke, the victim abnormal state determination unit 900 determines that the victim is in the abnormal state and sends a notification thereof to the medical institution server 1000. The medical institution server 1000 may immediately transmit a rescue request to the public safety agency server 600 to quickly rescue the victim.

The crime and emergency management system according to the present disclosure may be associated with the medical institution server 1000 which may play an important role in protecting the safety of victims and saving lives.

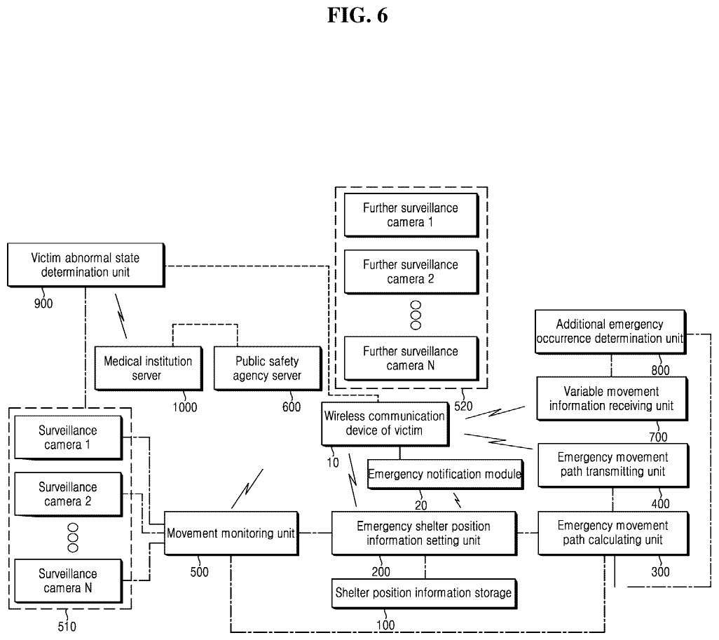

FIG. 6 is a block diagram showing a configuration in which the crime and emergency management system according to the present disclosure operates an emergency notification module in a remote manner.

Furthermore, when the emergency shelter position information setting unit 200 receives the emergency signal from the wireless communication device 10 of the victim in a wireless communication scheme, the emergency shelter position information setting unit 200 may forcibly operate the emergency notification module 20 included in the wireless communication device 10 of the victim in a remote control scheme.

Accordingly, when an emergency situation occurs, the emergency shelter position information setting unit 200 may forcibly operate the emergency notification module 20 to additionally provide a function to further secure the victim's safety. This allows the wireless communication device 10 of the victim to ask for help from people around the victim, or to provide the position information thereof to the medical institution server and the public safety agency server 600 when the victim is in an emergency situation.

An operation of the configuration as shown in FIG. 6 will be described as follows.

When the victim is in an emergency situation, an emergency app (program) pre-installed on the wireless communication device 10 of the victim may be executed such that the wireless communication device 10 of the victim transmits the emergency signal to the emergency signal receiving unit of the emergency shelter position information setting unit 200 in a wireless communication scheme.

The emergency signal receiving unit receives the emergency signal. The victim wireless communication device position information recognition unit of the emergency shelter position information setting unit 200 recognizes the position information of the wireless communication device 10 of the victim based on the GPS.

The emergency shelter position information setting unit 200 may take the following actions based on the received emergency signal.

The emergency shelter position information setting unit 200 forcibly operates the emergency notification module 20 included in the wireless communication device 10 of the victim in a remote control scheme.

The emergency notification module 20 may notify people around the victim of the victim's emergency situation information (position information, emergency situation type, etc.) to request help for the victim.

The emergency notification module 20 may transmit the victim's position information to the public safety agency server 600 or to medical institution server 1000 to take a quick action.

In accordance with the present disclosure, the emergency shelter position information setting unit 200 may forcibly operate the emergency notification module 20 without the victim's consent therewith. This is intended so that the wireless communication device 10 of the victim may request help even when the victim is in an emergency situation and thus cannot operate the module directly.

Furthermore, when the emergency situation occurs, the emergency shelter position information setting unit 200 automatically forcibly operates the emergency notification module 20 such that rapid response thereto is made.

Furthermore, the emergency notification module 20 may notify emergency situation information to surrounding people around the victim through various schemes such as voice notification, text message, and screen notification.

This may help ensure the victim's safety by asking for help from people around the victim or informing position information thereof to the public safety agency server 600 or to medical institution server 1000 to take a quick action.

Furthermore, when the victim's position information is rapidly transmitted to the public safety agency server 600 and the medical institution server 1000, the public safety agency server 600 and the medical institution server 1000 may take a rapid action.

When the emergency situation occurs, the emergency shelter position information setting unit 200 automatically forcibly operates the emergency notification module 20. Thus, when a criminal commits a crime, the probability at which the criminal is caught by people around the victim increases due to the notification, thereby improving a crime prevention effect.

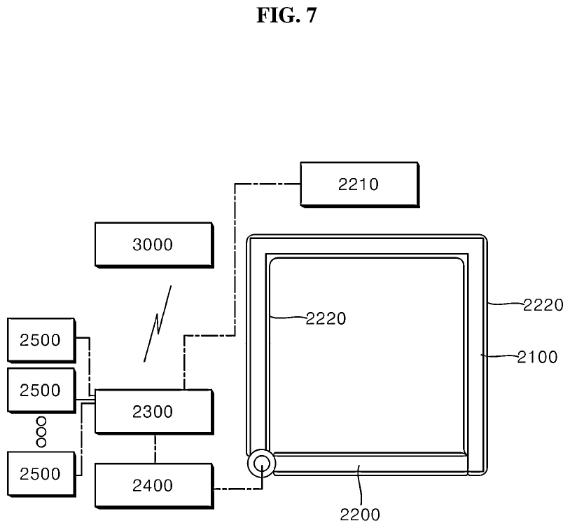

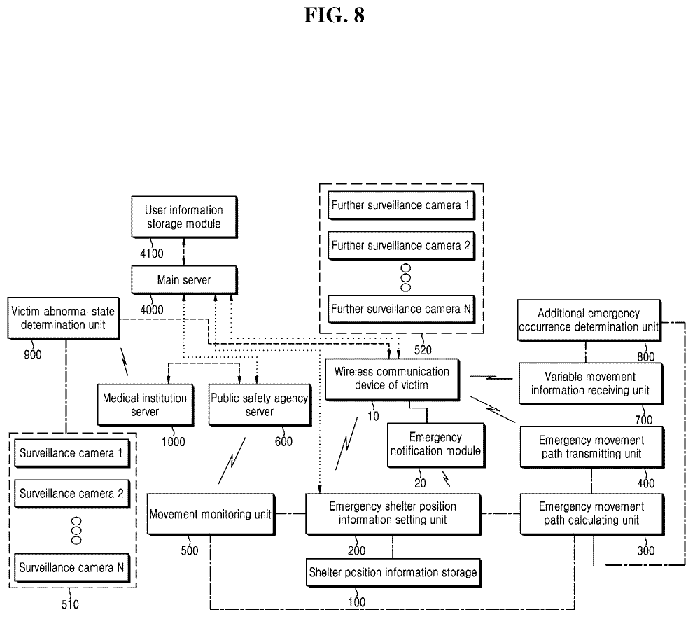

FIG. 7 is a drawing showing an example of a configuration of a shelter according to the present disclosure. FIG. 8 is a block diagram showing an example in which a crime and emergency management system according to the present disclosure further includes a monitoring server.

The crime and emergency management system according to the present disclosure further includes a monitoring server 3000.

The crime and emergency management system according to the present disclosure further includes shelters 2000.

Referring to FIG. 7 and FIG. 8, each of the shelters 2000 may be installed at a corresponding regional position, and may include a shelter body 2100 having a shelter space defined therein, and an entrance having at one side thereof, a door 2200 installed at the shelter body 2100 to open and close the entrance, and a driver 2400 that opens and closes the door 2200 under control of a controller 2300.

The controller 2300 may operate upon receiving a remote control signal from the monitoring server 3000.

When the position information of the wireless communication device 10 of the victim is positioned within a set proximity distance from the emergency shelter position information, the monitoring server 3000 may operate the controller 2300 to control the driver 2400 to open the door 2200 of the shelter 2000 positioned in the emergency shelter position information.

When the position information of the wireless communication device 10 of the victim has reached the shelter space of the shelter body 2100, the monitoring server 3000 may operate the controller 2300 to control the driver 2400 to close the door 2200.

Furthermore, air-filled members 2220 filled with air by an air filler 2210 are installed on inner and outer surfaces of each of the shelter body 2100 and the door 2200.

The shelter body 2100 and the door 2200 are provided with a shock sensor 2500 that detects an external impact force.

The safety of the shelter 2000 may be further strengthened by adding the air-filled member 2220 and the shock sensor 2500 to the shelter body 2100 and the door 2200.

Hereinafter, an effect of the air-filled member 2220 will be described.

The air-filled member 2220 may be disposed on the inner surface and the outer surface of the shelter and may be filled with air to expand, thereby absorbing internal and external shocks to allow the victim to stay in the shelter in a safe and comfortable manner after the evacuation.

The shelter may be made of a bulletproof material having fire resistance. This helps protect the victim from criminal attacks and ensures a safe evacuation time even in the event of a fire.

According to the present disclosure, the shock sensor 2500 may transmit detected information to the monitoring server 3000 or the public safety agency server 600 to enable a rapid rescue request.

The position information of the wireless communication device 10 of the victim has reached the evacuation space or the shelter space of the shelter body 2100 such that the door 2200 is forcibly closed. In this state, the shock sensor 2500 may detect the external impact force to the monitoring server 3000. When the monitoring server 3000 determines that the detected external impact force exceeds an emergency impact force set in the controller, the monitoring server 3000 may transmit information indicating that a criminal may invade into the shelter to the public safety agency server 600 in a wireless communication manner.

The monitoring server 3000 may output an emergency indicating sound to an outside using a speaker 2600 provided on the shelter 2000.

An operation of the crime and emergency management system according to the present disclosure further including the monitoring server 3000 will be described.

When the victim is in an emergency situation, an emergency app (program) pre-installed on the wireless communication device 10 of the victim may be executed such that the wireless communication device 10 of the victim transmits the emergency signal to the emergency signal receiving unit of the emergency shelter position information setting unit 200 in a wireless communication scheme.

The emergency signal receiving unit receives the emergency signal. The victim wireless communication device position information recognition unit of the emergency shelter position information setting unit 200 recognizes the position information of the wireless communication device 10 of the victim based on the GPS.

The emergency shelter position information setting unit 200 selects the shelter 2000 closest to the position information of the wireless communication device 10 of the victim, and sets the position information of the selected shelter 2000 as the emergency shelter position information.

The emergency movement path calculating unit 300 calculates the optimal emergency movement path based on the position information of the wireless communication device 10 of the victim and the emergency shelter position information.

The emergency movement path transmitting unit 400 transmits the calculated emergency movement path to the wireless communication device 10 of the victim.

While the victim moves along the emergency movement path, the monitoring server 3000 tracks the position information of the wireless communication device 10 of the victim in real time.

When the position information of the wireless communication device of the victim is positioned within a set proximity distance from the emergency shelter position information, the monitoring server 3000 automatically opens the door 2200 of the shelter 2000.

When the victim safely enters the shelter 2000, the monitoring server 3000 automatically closes the door 2200 of the shelter 2000.

The above configuration may be applied to an actual example as follows. When the victim is attacked by a criminal and runs away, the victim transmits an emergency signal through the emergency app. The crime and emergency management system according to the present disclosure selects the nearest shelter based on the victim's position information and automatically opens the door of the selected shelter. Thus, the victim may safely enter the selected shelter and hide therein.

The crime and emergency management system according to the present disclosure may more effectively secure the victim's safety, reduce the victim's evacuation time by automating the evacuation process, and may block criminal access to the shelter, and protect the victim there from.

In one embodiment, the crime and emergency management system according to the present disclosure further includes a main server 4000.

The main server 4000 may include a user information storage module 4100 that may use a service provided from the crime and emergency management system' according to the present disclosure.

The user information storage module 4100 may store therein unique information of each of users' wireless communication devices 10. Accordingly, the main server 4000 may permit only the wireless communication devices 10 having the unique information stored in the user information storage module 410 to use the service provided from the above-mentioned system. That is, the wireless communication device 10 of the victim is one of the wireless communication devices 10 having the unique information stored in the user information storage module 410.

The main server 4000 may grant permission for the authorized wireless communication device 10 to use the service provided from the above-mentioned system for a certain period of time via paid payment for a service fee.

However, in a case where an app with a user interface is installed on a wireless communication device for which the permission to use the service has not been granted, the service provided from the crime and emergency management system according to the present disclosure may be used by the wireless communication device in an emergency situation. Then, after a certain period of time, the system may send a message to the wireless communication device to pay the service usage fee.

In other words, the crime and emergency management system according to the present disclosure may allow the wireless communication device to use the service without payment in an emergency situation and then may request the wireless communication device to pay for the service use fee.

For example, when a specific victim is attacked by a criminal and thus is in an emergency situation, the wireless communication device of the specific victim may transmit an emergency signal through the app installed therein even when the wireless communication device of the victim is not authorized to use the service.

The crime and emergency management system according to the present disclosure may receive the emergency signal from the wireless communication device of the victim and may provide the shelter information, the emergency movement path, etc. to the wireless communication device to secure the victim's safety.

After the emergency situation has been resolved, the crime and emergency management system according to the present disclosure may send the service usage fee payment instruction to the wireless communication device of the victim. Thus, the victim pays for the usage fee according to the instruction.

As a result, the crime and emergency management system according to the present disclosure may provide everyone having the emergency situation with the opportunity to use the service provided from the crime and emergency management system.

Furthermore, the crime and emergency management system according to the present disclosure may provide potential users with the opportunity to experience the service provided from the crime and emergency management system to expand use of the crime and emergency management system.

Furthermore, use of the service provided from the crime and emergency management system may be increased by reducing the victim's financial burden in the event of an emergency situation and allowing afterward payment for the service use.

According to the configurations and operations of the crime and emergency management system according to the present disclosure as described above, the crime and emergency management system having crime prevention and evacuation functions according to the present disclosure may provide a real-time evacuation guidance to the victim having an emergency situation due to a crime occurring in an external space such that the victim immediately evacuates to an adjacent safety shelter to effectively reduce crime damage.

Furthermore, the crime and emergency management system having crime prevention and evacuation functions according to the present disclosure may provide the victim to an evacuation path to a safe shelter, and track the victim's movement along the evacuation path in real time, and monitor in real time occurrence of the additional emergency situation as the victim moves along the evacuation path.

Furthermore, when the emergency situation occurs on the victim the crime, the emergency management system having crime prevention and evacuation functions according to the present disclosure may transmit the emergency situation to the public safety agency server 600 or the medical institution server 1000 adjacent to the victim, and monitor whether the victim moves safely along the evacuation path, based on image information acquired from the surveillance cameras 510 that may monitor the evacuation path. Further, upon determination that the additional emergency situation occurs on the evacuation path, the system may further transmit accurate information about the additional emergency situation to the medical institution server 1000 or the public safety agency server 600 to immediately resolve or cope with the emergency situation.

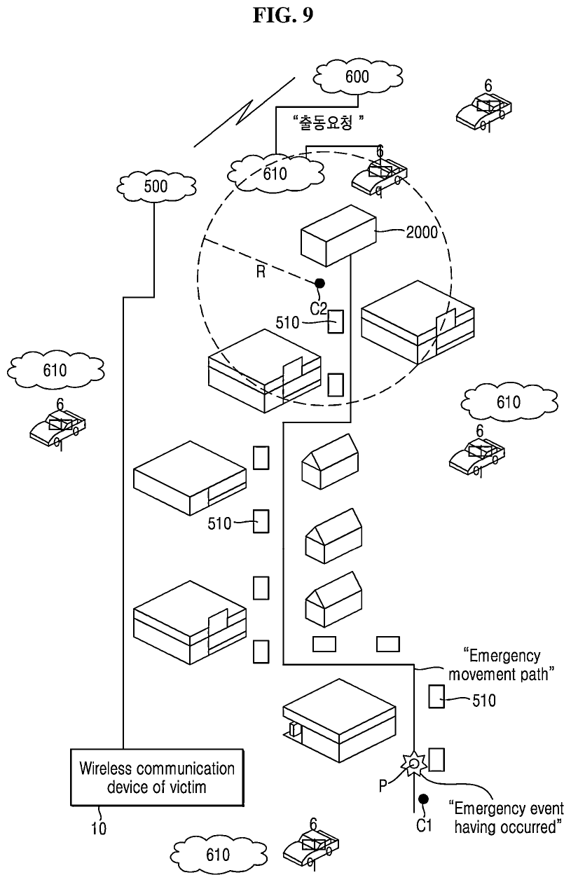

FIG. 9 is a diagram showing an example in which the crime and emergency management system having crime prevention and evacuation functions according to the present disclosure suppresses the occurrence of additional crimes.

Referring to FIG. 9, when an emergency situation occurs due to the crime of the first criminal C1 on the street, the wireless communication device 10 of the victim P may receive the emergency movement path calculated as described above and thus may receive guidance about movement to the corresponding shelter 2000. Thus, the victim P may move along the emergency movement path.

Further, a second criminal C2 in collusion with the first criminal C1 may be waiting for the victim P in a place around the shelter 2000. In this case, even when the victim P moves along the emergency movement path, the victim P may be exposed to the second criminal C2 and may be subjected to the additional damage.

The surveillance cameras 510 may be arranged along the emergency movement path. The surveillance cameras 510 acquire images of the moving victim and may transmit the images to the movement monitoring unit 500. The movement monitoring unit 500 may receive the images and transmit the images in real time to the public safety agency server 600 in a wireless communication manner.

The public safety agency server 600 may specify a person moving in a close manner to the victim moving along the emergency movement path as a potential criminal, and may obtain and temporarily store therein personal information including face information and body information about the specified potential criminal.

In this regard, personal information including face information of existing criminals who have been punished for causing existing crimes may be pre-stored in the public safety agency server 600.

The public safety agency server 600 may determine whether the temporarily stored personal information about the potential criminal matches with the personal information of the existing criminals.

Upon determination that the temporarily stored personal information of the potential criminal matches with the personal information of the existing criminals, the public safety agency server 600 may specify the potential criminal as the first criminal C1.

The public safety agency server 600 may acquire and analyze the images from the surveillance cameras 510 arranged along the emergency movement path, and may extract the face information of person included in the images and determine whether the extracted face information matches with the personal information of the existing criminals. Upon determination that the extracted face information matches with the personal information of the existing criminals, the public safety agency server 600 may specify the person having the extracted face information as the second criminal C2.

The second criminal C2 may exist at any position on the emergency movement path or may exist around the shelter.

Then, when both the first criminal C1 and the second criminal C2 as described above exist, the public safety management server 600 immediately identify the position information of the first and second criminals.

The public safety management server 600 may transmit the position information of the first and second criminals and the personal information of the first and second criminals, respectively, to regional public safety management servers 610 respectively positioned within a certain radius R from the position information of the first criminal C1 and the position information of the second criminal C2.

Next, each of the regional public safety management servers 610 may transmit dispatch instruction information to a wireless communication device 611 of each of patrol cars patrolling in a region within the certain radius R from each of the position information of the first criminal C1 and the position information of the second criminal C2. The dispatch instruction information may include each of the position information of the first criminal C1 and the position information of the second criminal C2 and a message to instruct the patrol car to move to the position information of each of the first and second criminals.

Accordingly, upon reception of the dispatch instruction information, the patrol car may move to the position information of each of the first and second criminals. As a result, the victim P may be protected as much as possible from additional crime damage caused by the second criminal C2 while the victim is moving to the shelter 2000.

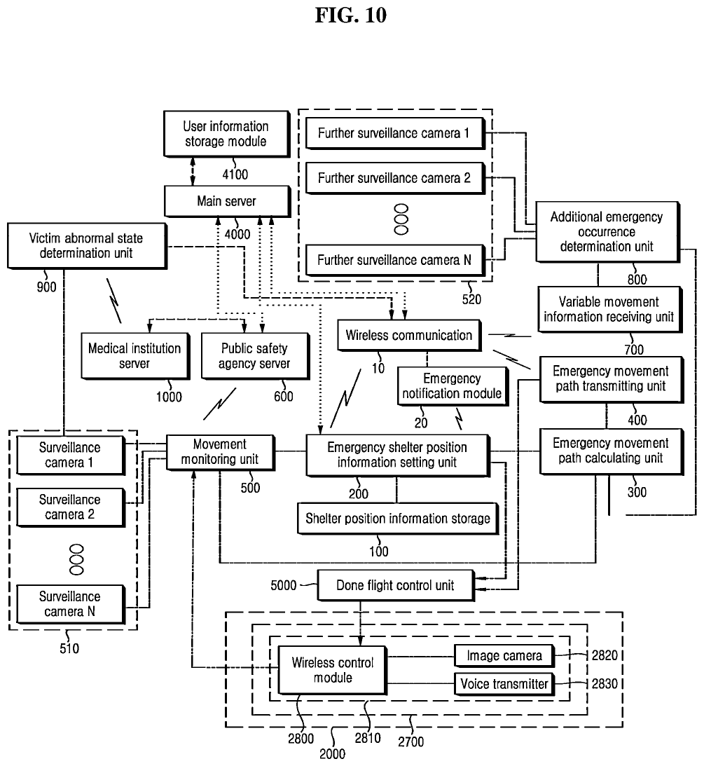

FIG. 10 is a block diagram showing an operation of the crime and emergency management system further including a drone flight control unit.

Referring to FIG. 10, the crime and emergency management system according to the present disclosure may include a drone flight control unit 5000.

Each of the shelters 2000 is equipped with a drone station 2700. At the drone station 2700, a drone 2800 capable of flight in a powered manner by its own battery is placed. The drone 2800 includes a wireless control module 2810 that establishes wireless communication with the drone flight control unit 5000.

The drone flight control unit 5000 may transmit a flight control signal to the wireless control module 2810 of the drone 2800 to control the flight of the drone 2600 provided in each of the shelters 2000.

The drone flight control unit 5000 receives position information of the wireless communication device 10 of the victim from the emergency shelter position information setting unit 200.

The drone flight control unit 5000 receives the calculated emergency movement path from the emergency movement path transmitting unit 400.

The drone flight control unit 5000 controls the drone 2800 provided in the shelter 2000 to fly to an area corresponding to the position information of the wireless communication device 10 of the victim.

Accordingly, the drone 2800 may fly so as to respond to change in the position information of the wireless communication device 10 of the victim and may acquire an image of the victim in real time using a camera 2820 thereof, and may transmit the acquired image to the movement monitoring unit 500 according to the present disclosure.

According to the present disclosure, the drone 2800 may fly to the position information of the wireless communication device 10 of the victim and acquire the image of the victim moving to the shelter 2000 and the image of the criminal on the movement path, and may transmit the image to the movement monitoring unit 500 which in turn may transmit the image to the public safety management server 600. Thus, the surveillance function in a blind spot where the surveillance cameras 510 are not installed may be supplemented to allow the victim to move safely to the shelter.

Furthermore, the drone 2800 is equipped with a voice transmitter 2830. A warning message in a voice form may be transmitted to surroundings around the victim moving along the emergency movement path through the voice transmitter 2830. Accordingly, the criminal who threatens the victim may receive the warning through the warning message and stop the criminal activity thereof. Therefore, the crime and emergency management system according to the present disclosure may significantly reduce the crime occurrence rate on the victim.

In addition, the shelter 2000 according to the present disclosure may include a drone station 2700. The drone 2800 may take off from the drone station 2700 and may land on the drone station 2700. Preferably, the drone station 2700 may be installed on a roof of the shelter 2000. A barrier (not shown) of a preset height may be installed on the roof of the shelter 2000 where the drone station 2700 is installed so as to surround the drone station 2700, thereby preventing an external intruder from reaching the drone station 2700.

The drone flight control unit 5000 receives the position information of the wireless communication device 10 of the victim from the emergency shelter position information setting unit 200.

The drone flight control unit 5000 receives the calculated emergency movement path from the emergency movement path transmitting unit 400.

The drone flight control unit 5000 controls the drone 2800 provided on the shelter 2000 to fly to an area corresponding to the position information of the wireless communication device 10 of the victim.

Accordingly, the drone 2800 flies in association with the change in the position information of the wireless communication device 10 of the victim and acquires an image of the victim in real time using the camera 2820 installed on the drone, and transmits the image to the movement monitoring unit 500 according to the present disclosure.

At the same time, the drone 2800 may establish wireless communication with the wireless communication device 10 of the victim through a separate wireless communication module. Accordingly, the drone 2800 may transmit a map image or voice information guiding the movement path to the position of the shelter 2000 to the wireless communication device 10 of the victim. As a result, the victim may safely evacuate to the shelter while receiving real-time guidance on the exact movement path to the relevant shelter from the flying drone 2800.

In one example, the shelter according to the present disclosure as described above also needs to cope with a gun accident. The shelter 2000 may be made of a bulletproof material, and preferably has a certain strength that may withstand the impact of a bullet fired from a firearm.

The bulletproof material may include one of steel, aramid fiber, high-strength concrete, and ceramic, or may be formed to cover a surface of at least a portion of the shelter.

The steel has high strength and durability. The aramid fiber has an excellent strength-to-weight ratio, is lighter than steel and is easier to process. The high-strength concrete is a mixture of steel and concrete. The ceramic has high hardness and heat resistance, and may provide excellent bulletproof performance against certain types of bullets.

A shape and a strength of the shelter 200 according to the present disclosure will be described.

The shelter 2000 may be formed in a shape of a box, and a corner of the box may be round.

The shelter 200 according to the present disclosure may be formed to have a curved shape to disperse a stress to increase structural stability.

In one example, in order to ensure safety from shooting accidents, it is recommended that the shelter meets a following bulletproof performance:

It is recommended that the appropriate bulletproof rating be selected depending on the type of the gun being used and the threat level.

Examples of bulletproof ratings include: NIJ II-A grade against general handguns, NIJ III-A grade or NIJ III grade against rifles and shotguns.

A thickness of the bulletproof material may be variable according to the bulletproof grade.

For example, NIJ II-A grade may employ 12.7 mm thick AR500 bulletproof steel plate, NIJ III-A grade may employ 25.4 mm thick AR500 bulletproof steel plate, and NIJ III grade may employ 38.1 mm thick AR500 bulletproof steel plate.

In addition, according to the present disclosure, the bottom of the shelter 2000 is preferably supported by a concrete structure pre-constructed underground, and the inner space of the shelter 2000 is connected to an auxiliary ventilation channel (not shown).The auxiliary ventilation channel may be embodied as a pipe connected to another position on the ground through the inner space of the shelter and the concrete structure. When an internal area size of the auxiliary ventilation channel is larger than a predetermined value, the auxiliary ventilation channel may be used as a movement path through which the victim may move to the another position.

All the components that constitute the embodiment of the present disclosure are described as being combined with each other or operating in combination with each other. However, the present disclosure is not necessarily limited to this embodiment. In other words, within the scope of the purpose of the present disclosure, all of the components may operate in a selective combination manner of at least two thereof with each other.

Although the operations are shown as being executed in a specific order in the drawings, it should not be understood that the operations should be performed in the specific order as shown or in a sequential order or that all illustrated operations should be performed to obtain the desired result.

Furthermore, each of the components may be implemented as an independent hardware or software or a combination thereof. However, some or all of the components may be selectively combined with each other. Each of the components may be implemented using a computer program. Codes and code segments that constitute the computer program may be easily deduced by a person skilled in the art from the present disclosure. The computer program may be stored in computer readable media and read and executed by a computer, thereby implementing the method of the present disclosure. The storage media for storing the computer program may include storage media including magnetic recording media, optical recording media, and semiconductor recording devices. Additionally, the computer program implementing an embodiment of the present disclosure includes a program module configured to is transmitted in real time through an external device.

Although the embodiments of the present disclosure have been described above with reference to the accompanying drawings, the crime and emergency management system according to the present disclosure may not be limited to the embodiments and may be implemented in various different forms. Those of ordinary skill in the technical field to which the present disclosure belongs will be able to appreciate that the present disclosure may be implemented in other specific forms without changing the technical idea or essential features of the present disclosure. Therefore, it should be understood that the embodiments as described above are not restrictive but illustrative in all respects.

What is claimed is:

1. A crime and emergency management system with crime prevention and evacuation functions, the crime and emergency management system comprising:
a shelter position information storage in which position information of shelters are stored;
an emergency shelter position information setting unit configured to:
receive an emergency signal from a wireless communication device of a victim having an emergency in a wireless communication manner;
recognize position information of the wireless communication device of the victim having transmitted the emergency signal based on GPS (Global Positioning System);
select position information of a shelter adjacent to the recognized position information of the wireless communication device of the victim from among the position information of the shelters stored in the shelter position information storage; and
set the selected position information as emergency shelter position information;
an emergency movement path calculating unit configured to calculate an emergency movement path from the position information of the wireless communication device of the victim to the set emergency shelter position information; and
an emergency movement path transmitting unit configured to transmit the calculated emergency movement path to the wireless communication device of the victim.

2. The crime and emergency management system of claim 1, wherein the crime and emergency management system further comprises:
surveillance cameras arranged along the calculated emergency movement path; and
a movement monitoring unit connected to the surveillance cameras in a wireless communication manner,
wherein while the wireless communication device of the victim moves along the calculated emergency movement path, the surveillance cameras acquire images of the moving victim in real time and transmit the images to the movement monitoring unit,
wherein the movement monitoring unit is configured to determine, based on the images of the victim acquired in real time, whether the victim is present in the calculated emergency movement path,
wherein upon determination based on the images of the victim acquired in real time that the victim is present in the calculated emergency movement path, the movement monitoring unit is configured to determine that the victim is in a safe state,
wherein upon determination based on the image of the victim acquired in real time that the victim is absent in the calculated emergency movement path, the movement monitoring unit is configured to determine that the victim is in a damaged state,
wherein the movement monitoring unit is configured to identify a first position of a surveillance camera capturing an image on which the victim is absent for the first time, from among the surveillance cameras arranged in the calculated emergency movement path, based on based on the images of the victim acquired in real time,
wherein the movement monitoring unit is configured to identify a second position of a surveillance camera capturing an image on which the victim is present and located just before the first position in the emergency movement path, from among the surveillance cameras arranged in the calculated emergency movement path, based on based on the images of the victim acquired in real time,
wherein the movement monitoring unit is configured to designate a path connecting the first and second positions to each other as an emergency path,
wherein the movement monitoring unit is configured to transmit the designated emergency path, position information of the wireless communication device of the victim on the designated emergency path, and the image acquired at each of the first and second positions to a public safety agency server in a wireless communication manner.

3. The crime and emergency management system of claim 1, wherein the crime and emergency management system further comprises a variable movement information receiving unit and an additional emergency occurrence determination unit,
wherein after the calculated emergency movement path is transmitted to the wireless communication device of the victim, the position information of the wireless communication device of the victim is variable such that movement information of the wireless communication device of the victim is variable,
wherein the variable movable information receiving unit is configured to receive the variable movement information of the wireless communication device of the victim in real time from the wireless communication device of the victim,
wherein the additional emergency occurrence determination unit is configured to:
determine whether the received variable movement information of the wireless communication device of the victim coincides with the emergency movement path; and
upon determination that the received variable movement information of the wireless communication device of the victim does not coincide with the emergency movement path, determine that an additional emergency has occurred.

4. The crime and emergency management system of claim 3, wherein the additional emergency occurrence determination unit is configured to transmit the position information of the wireless communication device of the victim based on the Gusto the public safety agency server at a time point when the additional emergency situation occurs.

5. The crime and emergency management system of claim 4, wherein when the position information of the wireless communication device of the victim is not identified based on the GPS at the time point at which the additional emergency situation occurs,
the additional emergency occurrence determination unit is configured to:
set a circular area having a predetermined radius around a point where the additional emergency situation occurs as an additional emergency area;
acquire additional images using other surveillance cameras disposed within the set additional emergency area; and
transmit information about the set additional emergency area and the acquired additional images to the public safety agency server.

6. The crime and emergency management system of claim 5, wherein the crime and emergency management system further comprises a victim abnormal state determination unit,
wherein the victim abnormal state determination unit is configured to:
process the images acquired in real time from the surveillance cameras;
calculate a moving speed of the victim based on a victim image included in the acquired images;
upon determination that the calculated movement speed of the victim decreases to a preset abnormal speed or is calculated as 0, determine that the victim is in an abnormal state; and
transmit abnormal state-related information to a medical institution server positioned within a set radius around a position of the victim at which the victim is determined to be in the abnormal state in a wireless communication manner,
wherein the abnormal state-related information include:
information based on which the victim abnormal state determination unit determines the victim to be in the abnormal state; and
position information of the wireless communication device of the victim at a time point at which the victim abnormal state determination unit determines the victim to be in the abnormal state.

7. The crime and emergency management system of claim 6, wherein as soon as the medical institution server receives the abnormal state-related information from the victim abnormal state determination unit, the medical institution server is configured to the abnormal state-related information to the public safety agency server in a wireless communication manner.

8. The crime and emergency management system of claim 7, wherein when the emergency shelter position information setting unit has received the emergency signal from the wireless communication device of the victim in the wireless communication scheme, the emergency shelter position information setting unit is configured to forcibly operate an emergency notification module included in the wireless communication device of the victim in a remote control manner.

9. The crime and emergency management system of claim 8, wherein the crime and emergency management system further comprises shelters and a monitoring server,
wherein each of the shelters is installed at a corresponding regional position,
wherein each of the shelters includes:
a shelter body having a shelter space having defined therein, and an entrance defined at a side surface of the shelter body;
a door installed on the shelter body and configured to open and close the entrance;
a driver configured to move the door; and
a controller configured to control the driver,
wherein the controller is configured to control the driver, upon receiving a remote control signal from the monitoring server,
wherein when the position information of the wireless communication device of the victim is positioned within a set proximity distance from the emergency shelter position information, the monitoring server is configured to instruct the controller to control the driver to move the door of the shelter positioned in the emergency shelter position information so as to open the entrance,
wherein when the position information of the wireless communication device of the victim has reached the shelter space of the shelter body, the monitoring server is configured to instruct the controller to control the driver to move the door of the shelter positioned in the emergency shelter position information to close the entrance.

10. The crime and emergency management system of claim 9, wherein an air-filled member filled with air by an air filler is disposed on an inner surface and an outer surface of each of the shelter body and the door,
wherein a shock sensor is disposed on the shelter body and the door to detect an external impact force,
wherein upon determination that, in a state in which the position information of the wireless communication device of the victim has reached the shelter space of the shelter body such that the door has been forcibly closed, the detected external impact force exceeds an emergency impact force set in the controller,
the monitoring server is configured to:
transmit information indicating that a criminal can invade into the shelter to the public safety agency server in a wireless communication manner; and
control a speaker provided on the shelter to output an emergency indicating sound to an outside.
